(19) United States
(12) Patent Application Publication
(10) Pub. No.: US 2019/0165410 A1
(43) Pub. Date: May 30, 2019

(54) REMOVING RESIDUAL WATER FROM LITHIUM-BASED ENERGY STORAGE DEVICES

(71) Applicant: GM GLOBAL TECHNOLOGY OPERATIONS LLC, Detroit, MI (US)

(72) Inventors: Zhiqiang YU, Shanghai (CN); Haijing LIU, Shanghai (CN)

(73) Assignee: GM GLOBAL TECHNOLOGY OPERATIONS LLC, Detroit, MI (US)

(21) Appl. No.: 16/092,389

(22) PCT Filed: May 4, 2016
(86) PCT No.: PCT/CN2016/080954

§ 371 Date: Oct. 9, 2018

(51) Int. Cl. H01M 10/058; H01M 10/052; H01M 4/04; H01G 11/06; H01G 11/62; H01G 11/52; H01G 11/28; H01G 11/60; H01G 11/84; H01G 11/20

(52) U.S. Cl. CPC H01M 10/058; H01M 10/052; H01M 4/04; H01G 11/06; H01G 11/20; H01G 11/52; H01G 11/28; H01G 11/60; H01G 11/84; H01G 11/62

(57) ABSTRACT

A method involves contacting a material for a lithium-based energy storage device with a supercritical substance maintained at or above its critical point. A lithium-based energy storage device is also provided, in which at least one of the various component parts (battery separator, lithium salt, negative electrode, negative current collector, positive electrode, and positive current collector) is substantially free of residual water by contact with the supercritical substance maintained at or above its critical point.

### TECHNICAL FIELD

The present disclosure relates generally to lithium-based energy storage devices, such as lithium-based batteries and lithium-ion capacitors, and, in particular, to removing residual water out of the materials that constitute the energy storage devices.

### BACKGROUND

Secondary, or rechargeable, lithium-based batteries are often used in many stationary and portable devices, such as those encountered in the consumer electronic, automobile, and aerospace industries. The lithium class of batteries has gained popularity for various reasons, including a relatively high energy density, a general nonappearance of any memory effect when compared to other kinds of rechargeable batteries, a relatively low internal resistance, and a low self-discharge rate when not in use. The ability of lithium batteries to undergo repeated power cycling over their useful lifetimes makes them an attractive and dependable power source.

Lithium-ion capacitors may be used in conjunction with, or in place of, lithium-based batteries and are ideal when a quick charge is needed to fill a short-term power need, whereas batteries are often chosen to provide long-term energy. Lithium-ion capacitors (LIC) are often used in applications that require a high energy density, high power density, and excellent durability.

Combining the lithium-ion capacitors with lithium-based batteries to form a hybrid battery satisfies both needs (i.e., is capable of providing short-term power and long-term energy) and reduces battery stress, which reflects in a longer service life.

### SUMMARY

A method according to an example of the present disclosure includes: contacting a material for a lithium-based energy storage device with a supercritical substance maintained at or above its critical point to remove water from the material. The method is for removing residual water from materials used to make lithium-based energy storage devices, such as lithium-based batteries and lithium-ion capacitors.

A lithium-based energy storage device includes: an electrolyte maintained in a separator, the separator having two sides; a lithium salt dissolved in the electrolyte; a negative electrode disposed on one side of the separator; a negative current collector associated with the negative electrode; a positive electrode disposed on an opposite side of the separator; and a positive current collector associated with the positive electrode.

At least one of the battery separator, the lithium salt, the negative electrode, the negative current collector, the positive electrode, and the positive current collector are substantially free of residual water as a result of contact with a supercritical substance maintained at or above its critical point.

### BRIEF DESCRIPTION OF THE DRAWINGS

Features of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 depicts a generic, schematic view of a lithium-based battery, according to an example.

FIG. 2 depicts a generic, schematic view of a lithium-ion capacitor, according to an example.

FIG. 3, on coordinates of pressure P (bar) and temperature T (Kelvin), depicts a pressure-temperature phase diagram of a supercritical fluid, here, CO₂, according to an example.

### DETAILED DESCRIPTION

Lithium-based batteries generally operate by reversibly passing lithium ions between a negative electrode (sometimes called an anode) and a positive electrode (sometimes called a cathode). The negative and positive electrodes are situated on opposite sides of a porous polymer separator soaked with an electrolyte solution that is suitable for conducting the lithium ions. During charging, lithium ions are inserted into the negative electrode, and during discharging, lithium ions are extracted from the negative electrode. Each of the electrodes is also associated with respective current collectors, which are connected by an interruptible external circuit that allows an electric current to pass between the negative and positive electrodes. Examples of lithium-based batteries include a lithium ion battery (i.e., which includes a lithium-based positive electrode paired with a negative electrode or a non-lithium positive electrode paired with a lithium or lithiated negative electrode), a lithium sulfur battery (i.e., which includes a sulfur based positive electrode paired with a lithium or lithiated negative electrode), and a lithium metal battery (i.e., which includes lithium-based positive and negative electrodes).

Lithium-based batteries, including lithium ion, lithium-sulfur (or silicon-sulfur), lithium-lithium, and lithium-metal, may include a lithium salt in the electrolyte. Examples of such lithium salt include LiPF₆, LiBF₄, and LiCl₄. These salts act as the source of lithium ion supply in the battery. Fluoride lithium salts, such as LiPF₆, may be chosen for use in the electrolyte because they are suitable for obtaining a battery of high voltage and high capacity. However, the electrolyte based on such fluoride solutes is very sensitive to moisture. Over the lifetime of the battery, LiPF₆ can degrade, forming LiF and PF₅, particularly in the presence of even small amounts of water.

A lithium-ion capacitor (LIC) is a hybrid electrochemical energy storage device which combines the intercalation (or insertion) mechanism of a lithium ion battery with the absorption mechanism of an electric double-layer capacitor (EDLC). One of the electrodes (either cathode or anode) is essentially pure EDLC material, such as activated carbon, only with the absorption/desorption reaction on the surface of electrode. At the same time, the other electrode (either anode or cathode) is essentially pure lithium ion battery material, such as carbon material which is pre-doped with lithium ions or lithium titanium oxide, etc., with the intercalation/de-intercalation (or insertion/de-insertion) reaction.

Lithium-ion capacitors have many of the same elements as lithium-based batteries. The term “lithium-based energy storage device” is used herein to include both Li-based batteries and Li-ion capacitors.

Water present in a lithium-based energy storage device may initiate a host of degradation products that can affect the electrolyte, anode and cathode of lithium-based batteries and lithium-ion capacitors. For example, LiPF₆ participates in an equilibrium reaction with LiF and PF₅. Under typical conditions, the equilibrium lies far to the left in Eqn. 1, shown below. However, the presence of water generates substantial LiF, an insoluble, electronically insulating product. LiF binds to the anode surface, increasing film thickness.

Hydrolysis of LiPF₆ yields PF₅, a strong Lewis acid that reacts with electron-rich species, such as water. PF₅ reacts with water to form hydrofluoric acid (HF) and phosphorus oxyfluoride (PF₃O). Phosphorus oxyfluoride in turn reacts to form additional HF and difluorohydroxy phosphoric acid.

The LiPF₆ decomposition reaction in the presence of water is as follows:

LiPF₆↔LiF↓+PF₅ (1)

PF₅+H₂O→PF₃O+2HF. (2)

HF is a very corrosive acid and can corrode cathode and current collectors, thereby decreasing the capacity of the energy storage device, and/or reducing the life cycle of the energy storage device.

Methods have been proposed to counter the HF effect. For example, costly dry rooms may be used to control the water level. Other solutions include using an organic solvent, such as ethanol, to extract water or using a basic metal oxide, such as MgO, to adsorb HF.

With regard to controlling the water level, the manufacturing process for making energy storage devices and/or energy storage device materials typically uses a desiccant dehumidifier. Normal levels of relative humidity (“RH”) may cause quality control problems in the lithium battery manufacturing process. Even ambient moisture present in the manufacturing room may degrade the “memory” characteristic (i.e., ability to hold charge) of the lithium. As such, the processing takes place in dry rooms, where the environment is made up of air with the dew point temperature being generally controlled at a very low relative humidity level (e.g., ranging from about 0.1% to about 5%, with one example being 0.5%).

However, even with current drying processes, it may be difficult to bring the water level in anodes and cathodes to desirable levels (e.g., about 100 ppm or less for the anode and about 300 ppm or less for the cathode).

In accordance with the present teachings, a method is provided for removing residual water in materials used in lithium-based energy storage devices. The method includes contacting the material with a supercritical substance maintained at or above its critical point. Examples of materials that may be suitably treated with the supercritical substance include battery material powder, electrodes, and cell cores. In one example, the battery material may be battery material powder (which in addition to the active material may include polymer binders, conductive fillers, etc.). In another example, the energy storage device material may be an electrode, such as a positive electrode or a negative electrode. In still another example, the electrode is a dry electrode coating including active material, polymer binder, and conductive filler. In yet another example, the energy storage device material may be a cell core (anode, separator, and cathode). In a further example, the cell core is a stacked or wound structure with positive and negative electrodes and the separator. In addition to electrodes, the material to be treated may include current collectors, separators, and salts used in electrolytes. It is to be understood that the energy storage device material may be any or all of the foregoing components to be used in a lithium ion battery, a lithium sulfur battery, a lithium-lithium battery, a lithium metal battery or a lithium-ion capacitor.

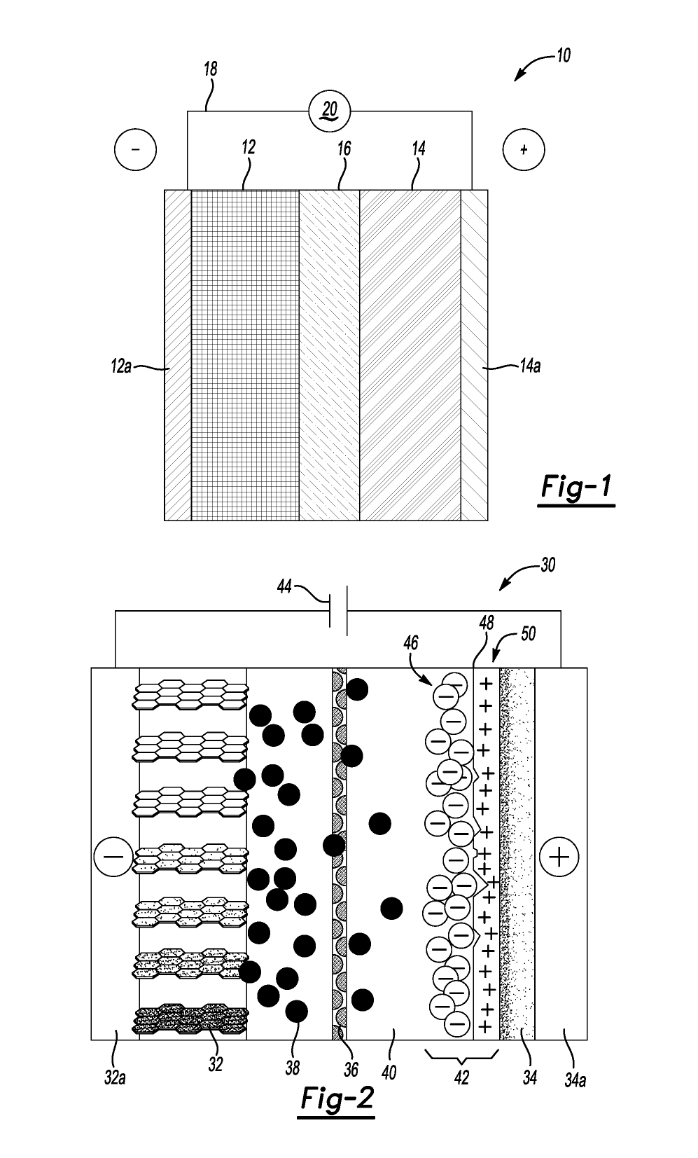

FIG. 1 in cross-section depicts a generic lithium-based battery 10 having a negative electrode 12 (anode), a positive electrode 14 (cathode), and an electrolyte-soaked porous separator 16 therebetween. Adjacent to the negative electrode 12 is a negative-side current collector 12a, which may be formed from copper. Adjacent to the positive electrode is a positive-side current collector 14a, which may be formed from aluminum.

The separator 16, which operates as both an electrical insulator and a mechanical support, is sandwiched between the negative electrode 12 and the positive electrode 14 to prevent physical contact between the two electrodes 12, 14 and the occurrence of a short circuit. The separator 16, in addition to providing a physical barrier between the two electrodes 12, 14, ensures passage of lithium ions and related anions through an electrolyte solution filling its pores. This helps makes sure that the lithium-based battery 10 functions properly.

The separator 16 may be a microporous polymer separator. The porosity of the separator 16 ranges from about 40% to about 60%. The thickness of the separator 16 ranges from about 10 μm to about 30 μm.

The separator 16 includes, or in some examples is, a membrane, and this membrane may be formed, e.g., from a polyolefin. The polyolefin may be a homopolymer (derived from a single monomer constituent) or a heteropolymer (derived from more than one monomer constituent), and may be either linear or branched. If a heteropolymer derived from two monomer constituents is employed, the polyolefin may assume any copolymer chain arrangement including those of a block copolymer or a random copolymer. The same holds true if the polyolefin is a heteropolymer derived from more than two monomer constituents. As examples, the polyolefin may be polyethylene (PE), polypropylene (PP), a blend of PE and PP, or multi-layered structured porous films of PE and/or PP.

In another example, the membrane of the separator 16 may be formed from another polymer chosen from polyethylene terephthalate (PET), polyvinylidene fluoride (PVdF), polyamides (Nylons), polyurethanes, polycarbonates, polyesters, polyetheretherketones (PEEK), polyethersulfones (PES), polyimides (PI), polyamide-imides, polyethers, polyoxymethylene (e.g., acetal), polybutylene terephthalate, polyethylenenaphthenate, polybutene, polyolefin copolymers, acrylonitrile-butadiene styrene copolymers (ABS), polystyrene copolymers, polymethylmethacrylate (PMMA), polyvinyl chloride (PVC), polysiloxane polymers (such as polydimethylsiloxane (PDMS)), polybenzimidazole (PBI), polybenzoxazole (PBO), polyphenylenes, polyarylene ether ketones, polyperfluorocyclobutanes, polytetrafluoroethylene (PTFE), polyvinylidene fluoride copolymers and terpolymers, polyvinylidene chloride, polyvinylfluoride, liquid crystalline polymers, polyaramides, polyphenylene oxide, and/or combinations thereof.

Each of the negative electrode 12, the positive electrode 14, and the porous separator 16 are soaked in the electrolyte solution. It is to be understood that any appropriate electrolyte solution that can conduct lithium ions between the negative electrode 12 and the positive electrode 14 may be used in the lithium-based battery 10. In one example, the electrolyte solution may be a non-aqueous liquid electrolyte solution that includes a lithium salt dissolved in an organic solvent or a mixture of organic solvents. Skilled artisans are aware of the many non-aqueous liquid electrolyte solutions that may be employed in the lithium-based battery 10, as well as how to manufacture or commercially acquire them.

The electrolyte solution may also include a number of additives, such as solvents and/or salts that are minor components of the solution. Example additives include lithium bis(oxalato borate) (LiBOB), lithium difluoro oxalate borate (LiDFOB), vinylene carbonate, monofluoroethylene carbonate, propane sultone, 2-propyn-ol-methanesulfonate, methyl di-fluoro-acetate, succinic anhydride, maleic anhydride, adiponitrile, biphenyl, ortho-terphenyl, dibenzyl, diphenyl ether, n-methylpyrrole, furan, thiophene, 3,4-ethylenedioxythiophene, 2,5-dihydrofuran, trishexafluoro-iso-propylphosphate, trihydroxybenzene, tetramethoxytitanium, etc. While some examples have been given herein, it is to be understood that other additives could be used. When included, additives may make up from about 0.05% to about 5% of the composition of the electrolyte solution.

The lithium-based battery 10 also includes an external circuit 18 and a load 20. The application of the load 20 to the lithium-based battery 10 closes the external circuit 18 and connects the negative electrode 12 and the positive electrode 14. The closed external circuit enables a working voltage to be applied across the lithium-based battery 10.

A discussion of the various lithium-based batteries is now presented, which provides additional information regarding the various battery materials employed in these batteries. Specifically discussed are the lithium ion battery, the lithium sulfur battery, and the lithium-lithium and lithium-metal batteries. Following the discussion of the batteries is a discussion of lithium-ion capacitors and then a presentation of further details of the supercritical fluid cleaning of the various storage energy device materials.

Lithium Ion Battery

The lithium ion battery includes a lithium-based positive electrode paired with a negative electrode or a non-lithium positive electrode paired with a lithium or lithiated negative electrode. The anode (negative) active materials for a negative electrode paired with a lithium positive electrode include: silicon (e.g., crystalline silicon, amorphous silicon), silicon oxide (SiOₓ), silicon alloys (e.g., Si—Sn), graphite, tin, alloys of tin, antimony, and alloys of antimony. The anode (negative) materials for a lithium negative electrode paired with non-lithium positive electrode: lithium foil, lithium alloys, lithium titanate, or any of the previous materials as long as the electrode is pre-lithiated.

For the lithium ion battery, the cathode (positive) active materials for a lithium-based positive electrode may include layered lithium transition metal oxides. For example, the lithium-based active material may be spinel lithium manganese oxide (LiMn₂O₄), lithium cobalt oxide (LiCoO₂), a manganese-nickel oxide spinel [Li(Mn_{1.5}Ni_{0.5})O₂], or a layered nickel manganese cobalt oxide (having a general formula of xLi₂MnO₃.(1−x)LiMO₂ (M is composed of any ratio of Ni, Mn and/or Co). A specific example of the layered nickel-manganese-cobalt oxide includes [xLi₂MnO₃.(1−x)Li(Ni_{1/3}Mn_{1/3}Co_{1/3})O₂]. Other suitable lithium-based active materials include Li(Ni_{1/3}Mn_{1/3}CO_{1/3})O₂, Li_{x+y}Mn_{2-y}O₄(LMO, 0<x<1 and 0<y<0.1), or a lithium iron polyanion oxide, such as lithium iron phosphate (LiFePO₄ or LFP) or lithium iron fluorophosphate (Li₂FePO₄F), or a lithium-rich layer structure. Still other lithium-based active materials may also be utilized, such as LiN₁₋ₓCo_{1-y}M_{x+y}O₂ or LiMn_{1.5-x}Ni_{0.5-y}M_{x+y}O₄ (M is composed of any ratio of Al, Ti, Cr, and/or Mg), stabilized lithium manganese oxide spinel (LiₓMn_{2-y}M_{y}O₄, where M is composed of any ratio of Al, Ti, Cr, and/or Mg), lithium nickel cobalt aluminum oxide (e.g., LiNi_{0.8}Co_{0.15}Al_{0.05}O₂) or NCA), aluminum stabilized lithium manganese oxide spinel (e.g., LiₓAl_{0.05}Mn_{0.95}O₂), lithium vanadium oxide (LiV₂O₅), Li₂MSiO₄ (where M is composed of any ratio of Co, Fe, and/or Mn), and any other high energy nickel-manganese-cobalt material (HE-NMC, NMC or LiNiMnCoO₂). By “any ratio” it is meant that any element may be present in any amount. So, in some examples, M could be Al, with or without Cr, Ti, and/or Mg, or any other combination of the listed elements. In another example, anion substitutions may be made in the lattice of any example of the lithium transition metal-based active material to stabilize the crystal structure. For example, any O atom may be substituted with an F atom.

The cathode (positive) active materials for non-lithium based active materials include: metal oxides, such as manganese oxide (Mn₂O₄), cobalt oxide (CoO₂), a nickel-manganese oxide spinel, a layered nickel manganese cobalt oxide, or an iron polyanion oxide, such as iron phosphate (FePO₄) or iron fluorophosphate (FePO₄F), or vanadium oxide (V₂O₅).

Lithium salts for the electrolyte of the lithium ion battery include: LiClO₄, LiAlCl₄, LiI, LiBr, LiSCN, LiBF₄, LiB(C₆H₅)₄, LiAsF₆, LiCF₃SO₃, LiN(FSO₂)₂(LIFSI), LiN(CF₃SO₂)₂ (LITFSI or lithium bis(trifluoromethylsulfonyl)imide), LiPF₆, LiB(C₂O₄)₂ (LiBOB), LiBF₂(C₂O₄) (LiODFB), LiPF₃(C₂F₅)₃ (LiFAP), LiPF₄(CF₃)₂, LiPF₄(C₂O₄) (LiFOP), LiPF₃(CF₃)₃, LiSO₃CF₃, LiNO₃, and mixtures thereof.

Electrode binder materials that may be used with preparing both anodes and cathodes include: polyvinylidene fluoride (PVdF), polyethylene oxide (PEO), an ethylene propylene diene monomer (EPDM) rubber, carboxymethyl cellulose (CMC), styrene-butadiene rubber (SBR), styrene-butadiene rubber carboxymethyl cellulose (SBR-CMC), polyacrylic acid (PAA), cross-linked polyacrylic acid-polyethylenimine, polyimide, or any other suitable binder material. Examples of the still other suitable binders include polyvinyl alcohol (PVA), sodium alginate, or other water-soluble binders.

Electrode conductive fillers that may be used in preparing both anodes and cathodes include: a high surface area carbon, such as acetylene black or another carbon material (e.g., Super P).

Lithium Sulfur Battery

The lithium sulfur battery includes a sulfur-based positive electrode paired with a lithium or lithiated negative electrode. The anode (negative) active materials include: lithium foil, lithium alloys, silicon (e.g., crystalline silicon, amorphous silicon, silicon oxide (SiOₓ), silicon alloys (e.g., Si—Sn), graphite, tin, alloys of tin, antimony, and alloys of antimony.

The cathode (positive) active materials include: a lithium/sulfur alloy or a sulfur/carbon composite. Specifically, for a lithium/sulfur alloy, any sulfur-based active material that can sufficiently undergo lithium alloying and dealloying with aluminum or another suitable current collector functioning as the positive terminal of the lithium-sulfur battery. Examples of sulfur-based active materials include S₈, Li₂S₈, Li₂S₆, Li₂S₄, Li₂S₂, and Li₂S. For a sulfur/carbon composite, an example is a weight ratio of S to C in the positive electrode ranging from 1:9 to 9:1.

For the lithium-sulfur battery, the electrolyte solution includes an ether-based solvent. Examples of the ether-based solvent include cyclic ethers, such as 1,3-dioxolane, tetrahydrofuran, 2-methyltetrahydrofuran, and chain structure ethers, such as 1,2-dimethoxyethane, 1-2-diethoxyethane, ethoxymethoxyethane, tetraethylene glycol dimethyl ether (TEGDME), polyethylene glycol dimethyl ether (PEGDME), and mixtures thereof.

The lithium salts for the electrolyte, the electrode binder, and the electrode conductive filler are the same as for the lithium ion battery.

Lithium-Lithium or Lithium Metal Battery

The lithium-lithium or lithium metal battery includes: lithium-based positive and negative electrodes. The anode (negative) active materials include: lithium foil, lithium alloys, and lithium titanate.

The cathode (positive) active materials include: lithium foil, lithium alloys, and other lithium-based active materials, such as those examples given for the lithium ion battery. The cathode active material may also include lithium titanate (LTO). In other lithium batteries, LTO may not be used as the cathode material because its pristine material does not contain any Li ions, unlike NMC, LFP, NCA, LMO, etc. materials. But, LTO could pair with Li metal for the Li—Li battery since in this case, Li metal in the anode can provide Li ions for the LTO cathode.

The lithium salts for the electrolyte, the electrode binder, and the electrode conductive filler are the same as for the lithium ion battery.

Lithium-Ion Capacitor

A supercapacitor (SC) (sometimes referred to as an ultracapacitor, and formerly known as an electric double-layer capacitor (EDLC)), is a high-capacity electrochemical capacitor with capacitance values much higher than other capacitors (but lower voltage limits) that bridge the gap between electrolytic capacitors and rechargeable batteries. A lithium-ion capacitor (LIC) is a hybrid type of capacitor in the family of supercapacitors, namely, a hybrid between so-called “double-layer capacitors” and so-called “pseudocapacitors”, having asymmetric electrodes and using both electrolytic and electrochemical charge storage. Essentially, the LIC combines the insertion/deinsertion mechanism of a lithium ion battery with one of the electrodes of an electric double-layer capacitor (EDLC).

The lithium ion capacitors consist of two electrodes, which may be separated by an ion-permeable membrane (separator), and an electrolyte ionically connecting both electrodes. When the electrodes are polarized by an applied voltage, ions in the electrolyte form electric double layers of opposite polarity to the cathode's polarity. For example, the positively polarized electrode (cathode) will have a layer of negative ions at the electrode/electrolyte interface along with a charge-balancing layer of positive ions adsorbing onto the negative layer.

Activated carbon may be used as the anode of the LIC. The cathode of the LIC may be made of a carbon material that is pre-doped with lithium ions. This pre-doping process lowers the potential of the cathode and allows a relatively high output voltage compared with other supercapacitors. The electrolyte used in an LIC is a lithium-ion salt solution that can be combined with other organic compounds. The electrolyte may be the same type of electrolyte that is used in lithium ion batteries.

FIG. 2 depicts an example of a lithium-ion capacitor 30. The LIC 30 has a pair of polarized asymmetric electrodes, anode 32 and cathode 34. Each electrode 32, 34 has a collector 32a, 34a respectively associated with it. A porous separator 36 separates the two electrodes 32, 34 and permits the flow of Li ions 38 therethrough. An electrolyte 40 is in contact with the two electrodes 32, 34 and the separator 36. The cathode 34 has a Helmholtz double layer 42 (the electrical double layer mentioned above) that is formed at the interface between the cathode 34 and the electrolyte 40. A power source 44 is electrically connected to the two collectors 32a, 34a.

When the electrodes 32, 34 are polarized by an applied voltage, ions in the electrolyte 40 form the electric double layers 42 of opposite polarity to the polarity of the cathode 34. For example, the positively polarized electrode (cathode) 34 has a layer 46 of negative ions at the electrode/electrolyte interface 48 along with a charge-balancing layer 50 of positive ions adsorbing onto the negative layer.

Lithium-ion capacitors 30 are constructed with two metal foils (current collectors 32a, 34a), each coated with electrode 32, 34 material, and each of which serves as the power connection between the electrode material and the external terminals of the capacitor. The electrodes 32, 34 are kept apart by the ion-permeable membrane (separator 36) used as an insulator to protect the electrodes 32, 34 against short circuits. This construction is subsequently rolled or folded into a cylindrical or rectangular shape and can be stacked in an aluminum can or an adaptable rectangular housing. Then the cell 30 is impregnated with a liquid or viscous electrolyte 40, which may be organic or aqueous. The electrolyte 40, an ionic conductor, enters the pores of the electrodes 32, 34 and serves as the conductive connection between the electrodes 32, 34 across the separator 36. Finally, the housing is hermetically sealed to ensure stable behavior over the specified lifetime.

The negative electrode (anode) 32 is commonly made with graphitic carbon material that can be doped and undoped with lithium to maximize energy density. The positive electrode (cathode) 34 often employs activated carbon material at which charges are stored in the electric double layer 42 that is developed at the interface between the electrode 34 and the electrolyte 40. In the case of cathode 34, the electrode material is activated carbon. Specific to the electrode material of the cathode 34 is its very large surface area. In an example, the activated carbon is electrochemically etched, so that the surface of the material is about a factor 100,000 times larger than the smooth surface.

The separator 36 is configured to physically separate the two electrodes 32, 34 to prevent a short circuit by direct contact. The separator 36 can be very thin (a few hundredths of a millimeter) and is very porous to the conducting ions in the electrolyte 40 to minimize ESR (equivalent series resistance). Furthermore, the separator 36 is chemically inert to protect the electrolyte's stability and conductivity. The separator 36 may be a capacitor paper or another inexpensive dielectric material. More sophisticated designs may use nonwoven porous polymeric films, such as polyacrylonitrile or KAPTON® (polyimide film from DuPont), woven glass fibers or porous woven ceramic fibers.

The current collectors 32a, 34a connect the electrodes 32, 34, respectively, to the capacitor's terminals (not shown). The collector 32a, 34a is either sprayed onto the electrode 32, 34, respectively, or is a metal foil. The current collectors 32a, 34a may be able to distribute peak currents of up to 100 A. If the housing (not shown) is made out of a metal (typically aluminum), the collectors 32a, 34a may be made from the same material to avoid forming a corrosive galvanic cell.

Supercritical Fluid

A supercritical fluid is a substance at a temperature and pressure at or above its critical point, where distinct liquid and gas phases do not exist. Like a gas, a supercritical fluid can diffuse through porous solids, and like a liquid, the supercritical fluid can dissolve materials.

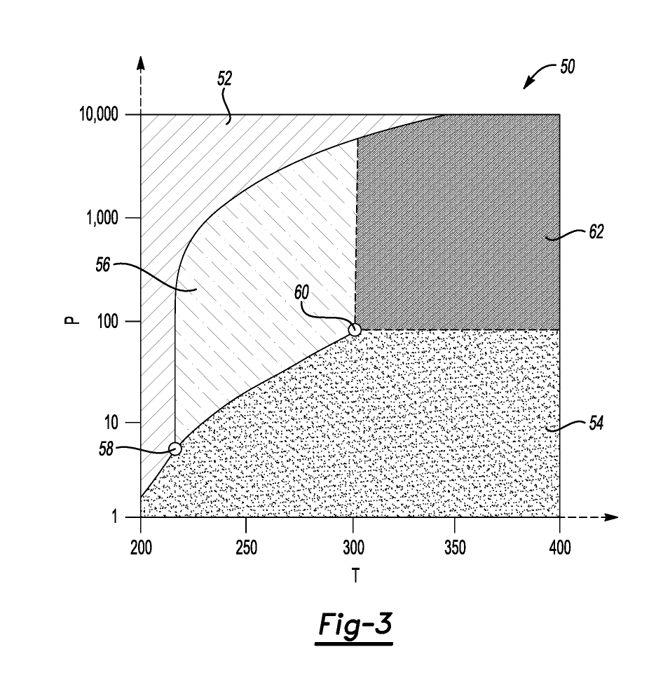

FIG. 3, on coordinates of pressure P (Y-axis: in bars) and temperature T (X-axis: in Kelvin) is a portion of a pressure-temperature phase diagram 50 of CO₂. CO₂ can exist in a solid phase 52, a gas phase 54, or a liquid phase 56. In thermodynamics, the triple point of a substance is the temperature and pressure at which the three phases (gas, liquid, and solid) of that substance coexist in thermodynamic equilibrium. The triple point 58 of CO₂ is shown at the point where the three phases 52, 54, and 56 coexist. At temperatures and pressures at or above a critical point 60, the CO₂ forms a supercritical fluid 62. Many other common fluids exhibit similar properties, although the specific critical temperatures and critical pressures may differ.

Examples of supercritical fluids useful in the practice of the method disclosed herein are listed in Table I below, along with their critical temperatures (in K), critical pressures (in bars), and critical densities (in g/m³).

TABLE I
Example Supercritical Fluids

| | Critical | Critical | Critical |
|---|---|---|---|
| | Temperature, | Pressure, | Density, |
| Solvent | K | bar | g/cm³ |
| Carbon dioxide (CO₂) | 304.1 | 74 | 0.47 |
| Methane (CH₄) | 190.4 | 46 | 0.16 |
| Ethane (C₂H₆) | 305.3 | 49 | 0.20 |
| Ethylene (C₂H₄) | 282.4 | 50 | 0.22 |
| Propane (C₃H₈) | 369.8 | 43 | 0.22 |
| Propylene (C₃H₆) | 364.9 | 46 | 0.23 |
| Methanol (CH₃OH) | 512.6 | 81 | 0.27 |
| Ethanol (C₂H₅OH) | 513.9 | 61 | 0.28 |
| Acetone (C₃H₆O) | 508.1 | 47 | 0.28 |
| Nitrous oxide (N₂O) | 306.57 | 74 | 0.45 |

The supercritical fluid may be used as-is. Alternatively, an alcohol may be added to the supercritical fluid to form a supercritical solution. This may increase the efficiency of water removal, since the presence of alcohol in the supercritical fluid may increase the water solubility so that the water removal efficiency may be increased. Examples of suitable alcohols may be low molecular weight alcohols (C1 to C4) selected from methanol, ethanol, propanol, butanol, their isomers, and mixtures thereof. If present, the concentration of the alcohol may be within a range of about 0.1 wt. % to about 50 wt. %. It will be appreciated that adding an alcohol to the supercritical flued may change the values of the critical temperature and critical pressure. However, these values can be easily determined by one skilled in the art. As alcohol is added, the water solubility inside the supercritical solution may be enhanced so that the water removal efficiency may be improved.

In either case, the energy storage device material is contacted with the supercritical substance (e.g., supercritical fluid or supercritical solution) for a period of time ranging from about 10 minutes to about 24 hours. As an example, the energy storage device materials, electrode sheet or stacked cell core may be placed into a stainless steel tank. The tank is sealed and the supercritical substance, such as CO₂ or CO₂ plus an alkanol, such as ethanol, is introduced into the tank. The temperature and pressure are increased until the critical conditions of the supercritical fluid are reached. The temperature and pressure are maintained for a period of time, such as 10 hours, to allow moisture water to dissolve into the supercritical substance. The tank is then quickly depressurized so that the supercritical substance with dissolved water is evaporated quickly, leaving the dried energy storage device materials, electrode sheet or stacked cell core.

The energy storage device separator 16, 36, the lithium salt, the negative electrode 12, 32, the negative current collector 12a, 32a, the positive electrode 14, 34, and/or the positive current collector 14a, 34a are/is rendered substantially free of residual water by contact with the supercritical substance maintained above its critical point. As an example of residual water remaining, the water level after this process would be less than 300 ppm for cathode material and less than 100 ppm for anode material.

It is to be understood that the ranges provided herein include the stated range and any value or sub-range within the stated range. For example, a range of from 1:9 to 9:1 should be interpreted to include not only the explicitly recited limits of from 1:9 to 9:1, but also to include individual values, such as 1:2, 7:1, etc., and sub-ranges, such as from about 1:3 to 6:3 (i.e., 2:1), etc. Furthermore, when “about” is utilized to describe a value, this is meant to encompass minor variations (up to +/−10%) from the stated value.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

In describing and claiming the examples disclosed herein, the singular forms “a”, “an”, and “the” include plural referents unless the context clearly dictates otherwise.

While several examples have been described in detail, it will be apparent to those skilled in the art that the disclosed examples may be modified. Therefore, the foregoing description is to be considered exemplary rather than limiting.

1. A method, comprising:
contacting a material for a lithium-based energy storage device with a supercritical substance maintained at or above its critical point to remove water from the material.

2. The method as defined in claim 1 wherein the lithium-based energy storage device includes:
an electrolyte maintained in a separator, the separator having two sides;
a lithium salt dissolved in the electrolyte;
a negative electrode disposed on one side of the separator;
a negative current collector associated with the negative electrode;
a positive electrode disposed on an opposite side of the separator; and
a positive current collector associated with the positive electrode;
wherein at least one of the separator, the lithium salt, the negative electrode, the negative current collector, the positive electrode, or the positive current collector is contacted by the supercritical substance prior to assembly in the lithium-based energy storage device.

3. The method as defined in claim 1 wherein the lithium-based energy storage device is selected from the group consisting of lithium ion batteries, lithium sulfur batteries, lithium-lithium batteries, lithium-metal batteries, and lithium-ion capacitors.

4. The method as defined in claim 1 wherein the supercritical substance is a supercritical fluid selected from the group consisting of carbon dioxide, methane, ethane, ethylene, propane, propylene, methanol, ethanol, acetone, nitrous oxide and mixtures thereof.

5. The method as defined in claim 1, further comprising adding an alcohol to the supercritical substance to form a supercritical solution to increase the efficiency of water removal.

6. The method as defined in claim 5 wherein the alcohol is selected from the group consisting of methanol, ethanol, propanol, and butanol, their isomers, and mixtures thereof.

7. The method as defined in claim 5 wherein the alcohol is present in the supercritical solution within a concentration range of about 0.1 wt. % to about 50 wt. %.

8. The method as defined in claim 1 wherein the battery material is contacted with the supercritical substance for a period of time ranging from about 10 minutes to about 24 hours.

9. A lithium-based energy storage device, comprising:
an electrolyte maintained in a separator, the separator having two sides;
a lithium salt dissolved in the electrolyte;
a negative electrode disposed on one side of the separator;
a negative current collector associated with the negative electrode;
a positive electrode disposed on an opposite side of the separator; and
a positive current collector associated with the positive electrode;
wherein at least one of the separator, the lithium salt, the negative electrode, the negative current collector, the positive electrode, or the positive current collector is substantially free of residual water as a result of contact with a supercritical substance maintained at or above its critical point.

10. The lithium-based energy storage device as defined in claim 9 wherein the supercritical substance is a supercritical fluid selected from the group consisting of carbon dioxide, methane, ethane, ethylene, propane, propylene, methanol, ethanol, acetone, nitrous oxide and mixtures thereof.

11. The lithium-based energy storage device as defined in claim 9 wherein the supercritical substance includes an alcohol to form a supercritical solution to increase the efficiency of water removal.

12. The lithium-based energy storage device as defined in claim 11 wherein the alcohol is selected from the group consisting of methanol, ethanol, propanol, butanol, isomers thereof, and mixtures thereof.

13. The lithium-based energy storage device as defined in claim 11 wherein the alcohol is present in the supercritical solution within a concentration range of about 0.1 wt. % to about 50 wt. %.

14. The lithium-based energy storage device as defined in claim 9, selected from the group consisting of lithium ion batteries, lithium sulfur batteries, lithium-lithium batteries, lithium-metal batteries, and lithium ion capacitors.

15. A method, comprising:
contacting a material for a lithium-based battery or a lithium-ion capacitor with a supercritical substance maintained at or above its critical point to remove water from the material, the material including at least one of:
an electrolyte maintained in a separator, the separator having two sides;
a lithium salt dissolved in the electrolyte;
a negative electrode disposed on one side of the separator;
a negative current collector associated with the negative electrode;
a positive electrode disposed on an opposite side of the separator; and
a positive current collector associated with the positive electrode;
wherein at least one of the separator, the lithium salt, the negative electrode, the negative current collector, the positive electrode, or the positive current collector is contacted by the supercritical substance prior to assembly in the lithium-based energy storage device.
